(19) United States
(12) Patent Application Publication
(10) Pub. No.: US 2015/0081398 A1
(43) Pub. Date: Mar. 19, 2015

(54) DETERMINING A PERFORMANCE TARGET SETTING

(71) Applicant: International Business Machines Corporation, Armonk, NY (US)

(72) Inventors: Chitra Dorai, Chappaqua, NY (US); Larry D. Huffman, Raleigh, NC (US); Bruce W. Jones, Pittsburgh, PA (US); Nan Shao, Elmsford, NY (US); Kevin M. Simback, Charlotte, NC (US); Alejandro Veen, New York, NY (US)

(73) Assignee: International Business Machines Corporation, Armonk, NY (US)

(21) Appl. No.: 14/029,340

(22) Filed: Sep. 17, 2013

(51) Int. Cl. G06Q 10/06

(52) U.S. Cl. CPC G06Q 10/06375; G06Q 10/067
USPC 705/7.37

(57) ABSTRACT

A method for setting a performance target in an outcome driven business model. The method includes receiving historical data, comprising industry performance data, for the outcome driven business model and performance target settings, including a forecasting horizon and confidence level. The method includes calculating, for a plurality of forecasting methods and the forecasting horizon, a function associated with a probability of an industry benchmark performance meeting a threshold value. The method includes determining, based on the function for each of the plurality of forecasting methods, a best forecasting method of the plurality of forecasting methods at the forecasting horizon and the confidence level. The method includes calculating, based on the historical data and the forecasting horizon, using the best forecasting method, a forecast benchmark value. The method includes setting a performance target based on the forecast benchmark value, the confidence level, and the function for the determined best forecasting method.

### FIELD OF THE INVENTION

The present invention relates generally to the field of outcome driven business models, and more particularly to determining a performance target setting in an outcome driven business model.

### BACKGROUND OF THE INVENTION

Outcome driven business models are characterized by reward or incentive agreements that are established between a client and an enterprise to influence the quality or outcome of a deliverable such as a good or service. The outcomes can often be performance levels achieved by the goods or services offered by the enterprise, such as a target number of new customers acquired via customer care function or a target percentage of debt collected in credit card payment collection operations. The incentive is typically based on performance levels of the services reaching a previously agreed upon target and the incentive can also vary as a function of the difference between an intended target and the actual level of the performance achieved. Such performance targets can be set as a pre-determined fixed value, or the performance targets can be set according to the value of an industry standard, also referred to as a benchmark, which allows for evaluation and comparison of the achieved performance with respect to an external reference. More often than not, when industry standards do not exist, the industry benchmark can be performance levels of competitors within the industry, which have been normalized for proper comparison.

In order to determine a value of an industry benchmark, an outcome driven business model needs to have a sense of different metrics, such as an average, a high, and a low performance of the competition, and also the volatility of the industry benchmark metrics. The industry benchmark metrics can be average revenue per user measured by mobile service providers, first call resolution percentage used in contact center operations, or percentage of customers who became delinquent for the first time which is tracked as entry rate in credit card and mortgage industries. Volatility provides a measure of variations in the competition's performance at different times of the year, or in different scenarios. In these circumstances, only observables can be the competition's performance values, without having any information about how the performance is achieved. A volatility based forecast allows an organization to assess how likely it is that their performance reaches or surpasses the varying benchmark performance. Having this assessment and setting achievable performance targets for its operations in such a way that its performance can exceed the industry benchmark is critical for an organization operating with an outcome driven business model, specifically for financial planning of incentives that can be accrued based on performance or budgeting purposes.

### SUMMARY

Embodiments of the present invention disclose a method, computer system, and computer program product for setting a performance target in an outcome driven business model. The method includes receiving, by one or more computer processors, historical data comprising industry performance data for the outcome driven business model and receiving performance target setting parameters, including at least a forecasting horizon and a confidence level. The method includes calculating, by the one or more computer processors, for a plurality of forecasting methods and the forecasting horizon, a function associated with a probability of an industry benchmark performance meeting a threshold value. The method includes determining, by the one or more computer processors, based, at least in part, on the function for each of the plurality of forecasting methods, a best forecasting method of the plurality of forecasting methods at the forecasting horizon and the confidence level. The method includes calculating, by the one or more computer processors, based, at least in part, on the historical data and the forecasting horizon, using the determined best forecasting method, a forecast benchmark value. The method then includes setting, by the one or more computer processors, a performance target based on the forecast benchmark value, the confidence level, and the calculated function for the determined best forecasting method.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a benchmark analysis program, for calculating a function f( ) used to set a performance target, in accordance with an embodiment of the present invention.

FIG. 3A depicts an exemplary user interface displaying forecast benchmarks compared to actual benchmark performance, from operation of the benchmark analysis program of FIG. 2, in accordance with an embodiment of the present invention.

FIG. 3B depicts an exemplary user interface displaying a plot of a step function determined by the benchmark analysis program of FIG. 2, and a corresponding smooth line representing function f( ), in accordance with an embodiment of the present invention.

FIG. 4 depicts a block diagram of components of the server computing device of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages, or any statistical and mathematical programming language, such as MATLAB®, IBM SPSS Statistics®, or the like. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

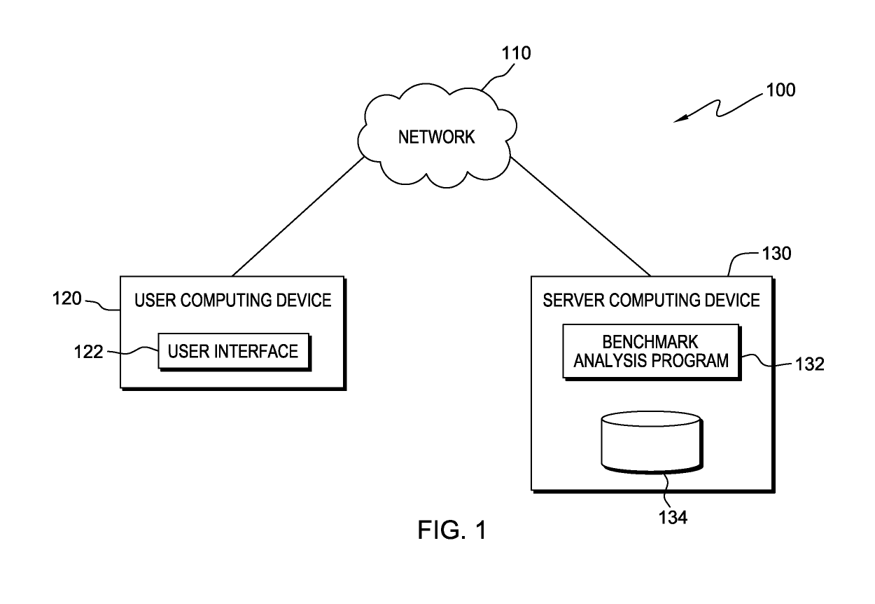

The present invention will now be described in detail with reference to the Figures. Referring to FIG. 1, a functional block diagram illustrating a distributed data processing environment is shown, generally designated 100, in accordance with one embodiment of the present invention. In an exemplary embodiment of the present invention, distributed data processing environment 100 represents an outcome-driven business model environment.

Distributed data processing environment 100 includes user computing device 120 and server computing device 130, interconnected via network 110. Network 110 can be, for example, a local area network (LAN), a wide area network (WAN) such as the Internet, or any combination of the two, and can include wired, wireless, or fiber optic connections. In general, network 110 can be any combination of connections and protocols that will support communication between user computing device 120 and server computing device 130.

User computing device 120 includes user interface (UI) 122. In various embodiments of the present invention, user computing device 120 can be a laptop computer, a notebook computer, a personal computer (PC), a desktop computer, a tablet computer, a handheld computing device or smart-phone, or any programmable electronic device capable of communicating with server computing device 130 via network 110. UI 122 may be, for example, a graphical user interface (GUI) or a web user interface (WUI) and can display text, images, messages, documents, web browser windows, user options, application interfaces, and instructions for operation. An operator of user computing device 120 can view results on UI 122 from operation of benchmark analysis program 132.

Server computing device 130 includes benchmark analysis program 132 and database 134. In various embodiments of the present invention, server computing device 130 can be a laptop computer, a tablet computer, a netbook computer, a PC, a handheld computing device or smart phone, a thin client, a mainframe computer, a networked server computer, or any programmable electronic device capable of communicating with user computing device 120 via network 110.

Benchmark analysis program 132 transforms data, such as historical data stored in database 134, for example, by applying a mathematical function to each point in a data set for use with various forecasting methods to forecast a level, trend and volatility of an industry benchmark metric that can be used to set an internal performance target within an organization. Benchmark analysis program 132 incorporates the volatility of the benchmark metric by calculating prediction bounds in addition to a forecast benchmark value. Benchmark analysis program 132, using performance target setting parameters, including a pre-determined confidence level and forecasting horizon, selects a best forecasting method which is used to calculate the forecast benchmark value and to set an internal performance target based on the forecast benchmark value and the prediction bounds of the forecast benchmark value. The confidence level is determined by a user, for example, of user computing device 120 within distributed data processing environment 100. In various embodiments of the present invention, the performance target can be set for an entire organization, departments or units within the organization, or for individual employees within the organization. Database 134, as described above, stores historical data for the industry and the organization. Stored data in database 134 can include trends, seasonal changes, and yearly effects on the historical data.

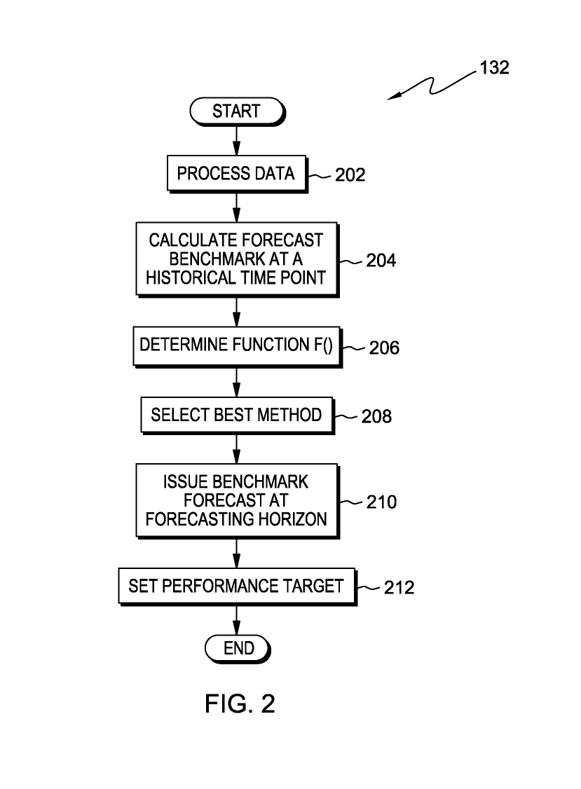

FIG. 2 is a flowchart depicting operational steps of benchmark analysis program 132, for forecasting a benchmark at historical time points and comparing with an actual historical benchmark performance, in order to calculate a function f( ) used to set a performance target, selecting the best method based on function f( ), issuing a benchmark forecast value for a future benchmark performance and calculating a prediction bound in order to set the performance target, in accordance with an embodiment of the present invention.

Benchmark analysis program 132 processes data (step 202). In an exemplary embodiment, benchmark analysis program 132 processes historical data for use in forecasting the benchmark (step 204). Historical data, including industry performance data, is stored in database 134 in distributed data processing environment 100. In various embodiments of the present invention, processing the data includes performing change point detection, for example, based on industry knowledge or change point detection methods known in the art, and performing outlier detection, for example, using both statistical testing and industry knowledge. In some embodiments, the outlier, or abnormal performance value, may need to be removed and replaced with an average performance value in order to obtain a reliable forecast. In an embodiment, a user operating user computing device 120 can make the determination to remove and replace an outlier with an average performance value.

Benchmark analysis program 132 calculates a forecast benchmark at a historical time point (step 204). For every forecast method M, including known methods in the art and an expert opinion method, historical data is used to forecast an industry benchmark value at a given forecasting horizon n, and compared to actual benchmark performance values at historical time points in the historical data. Forecasting horizon n is determined by a user operating user computing device 120. In various embodiments of the present invention, forecasting may be done by statistical forecasting methods known in the art, including, for example, linear regression, Holt-Winter's smoothing, autoregressive moving average (“ARMA”) model, autoregressive integrated moving average (“ARIMA”) model, simple moving averages, or any combination of known methods with different weights where the weight depends on predictability of the corresponding model. The methods used may depend on whether the historical data contains multiple cycles and seasonal variations.

In various embodiments of the present invention, an expert opinion forecast method may be used, which requires adequate forecast history in order to calculate function f( ). For example, if an organization performance target setting uses one-month ahead forecasting, in order to use expert opinion forecast method, historical expert opinion of one-month ahead forecast at different time periods is necessary, e.g., it is August 2013, and a performance target needs to be set for September 2013 (one-month ahead), a December 2012 historical expert opinion forecast for January 2013, a January 2013 expert opinion forecast for February 2013, and so on, is needed. If expert opinion forecast is only available for July and August 2013, and the July and August forecasts were issued in January 2013, there is no one-month ahead expert opinion forecast and the forecast history is inadequate to calculate function f( ).

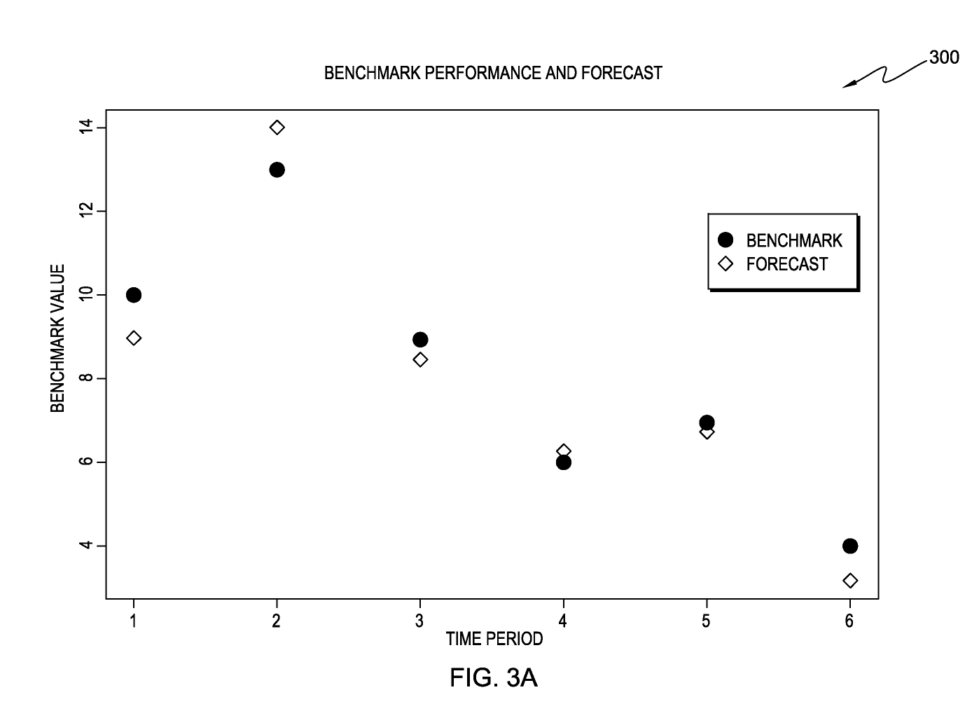

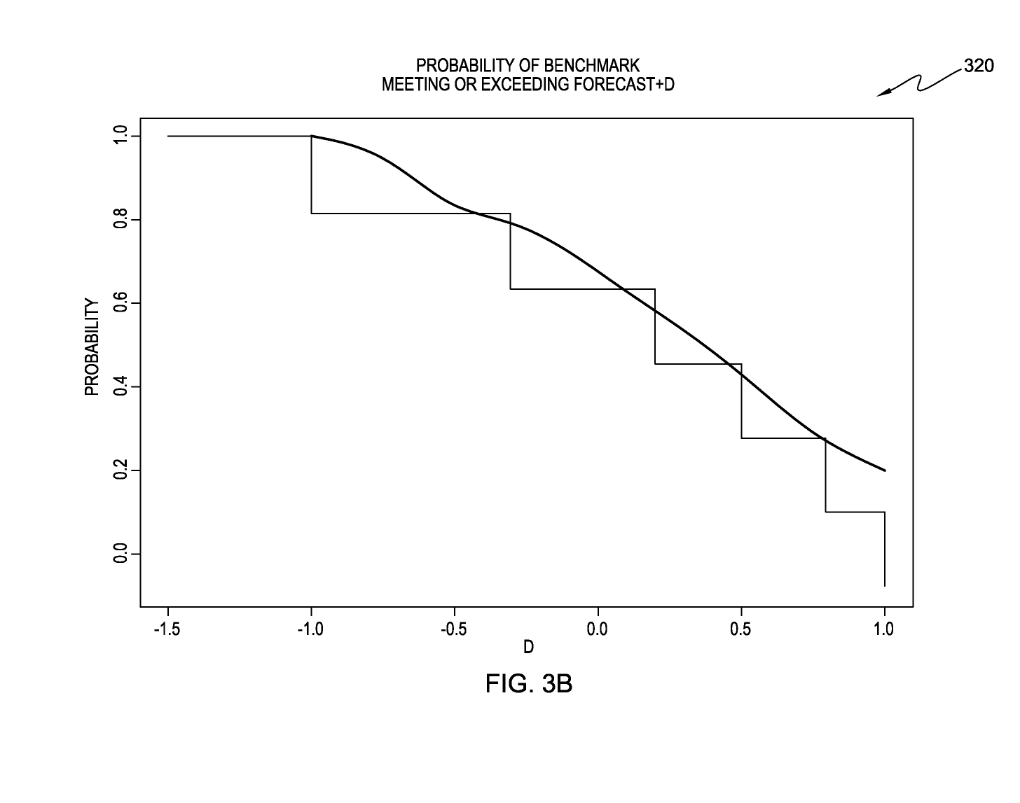

In order to forecast the industry benchmark value, benchmark analysis program 132 generates out-of-sample forecasts for the past performance of the benchmark, using known historical data. For example, for a given method M and a given forecasting horizon n, benchmark analysis program 132 divides the data into a training set and a testing set, and generates a series of forecasts at forecasting horizon n in a rolling window scheme. For example, using n=1 month, and 18 months of data for historical benchmark performance, a 12 month rolling window can be used as the length of the training set. The first 12 months of data (1^{st} month to 12^{th} month) is used to generate a “one-month-ahead forecast,” or a forecast for the 13^{th} month. Additionally, a forecast error is calculated, which is the difference between the 13^{th} month forecast value and the true, actual performance (from the known 18 months of data). Next, the next 12 months of data (2^{nd} month to 13^{th} month) is used to generate a forecast for the 14^{th} month, which is compared to the actual benchmark performance at the 14^{th} month to calculate a forecast error. Benchmark analysis program 132 continues with the rolling window scheme in this manner for each 12 month window within the 18 months of historical data, resulting in a series of six separate one-month-ahead forecasts, which can be compared to the actual benchmark performance to obtain a corresponding series of six forecast errors. The forecast errors are called “one-step-ahead forecast errors” because the process generates one-month-ahead forecasts, where n=1 and the step is equal to n. An exemplary plot showing calculated forecast benchmark and the forecast error with respect to actual benchmark performance is described further with reference to FIG. 3.

Benchmark analysis program 132 determines function f( ) (step 206). Function f( ) is determined by calculating a probability, represented as a percentage, of actual industry benchmark performance meeting or exceeding a certain threshold value, or prediction bound. Prediction bounds provide an estimate of a range, including an upper and lower bound, in which future industry benchmark performances will fall, with a certain probability or confidence level, based on the past performance. The percentage is determined by calculating, using the forecast errors from every given method M and the given forecasting horizon n obtained above, a [forecast+d] value for various values of d. In an exemplary embodiment of the present invention, using various values for d and corresponding probability values will generate a step function plot, described further with reference to FIG. 3. In various other embodiments of the present invention, a decreasing function is generated.

The calculation of the function f( ) is a semi-model based method. In an exemplary embodiment of the present invention, when all calculations are performed and the step function is generated, benchmark analysis program 132 applies a smoothing technique, such as kernel smoothing, to the step function to produce a smooth form line representing function f( ), as shown in FIG. 3B.

In an exemplary embodiment of the present invention, a large industry benchmark performance measurement represents a better performance, and the threshold value, or prediction bound, used is the upper prediction bound. In other various embodiments of the present invention, a lower prediction bound may be used for determining the probability of actual industry benchmark performance meeting or exceeding the threshold value, for example, when a smaller benchmark performance measurement is desired, such as an entry rate in a mortgage industry.

Benchmark analysis program 132 selects a best method (step 208). Different forecast methods generate different values for function f( ), and at the same forecasting horizon n, and with the same confidence level, one method may generate forecasts closer to actual performance and historical data than another. Benchmark analysis program 132 selects the model with the generated forecast benchmark value closest to the actual performance in the historical data. If two methods produce results that are equally close to the actual performance, benchmark analysis program 132 uses both methods to generate the forecast and uses an average value as a final forecast. In various embodiments of the present invention, for a given confidence level, a different method may be selected for different forecasting horizon n values. For example, one method may be used for a one-month-ahead forecast, and a second method may be used for a two-month-ahead forecast.

Once function f( ) is calculated, its value is set to be (1−[confidence level]/2), where the confidence level is pre-determined by a user of user computing device 120 within distributed data processing environment 100. For example, for a pre-determined confidence level of 80%, the value of function f( ) is set to (1−80%)/2 or 10%, and benchmark analysis program 132 solves for d′(M, n), which is the inverse of function f( ). Therefore, the performance target should be set such that there is only a 10% chance the industry benchmark performance will meet or exceed the set performance target. Given the forecasting horizon n used above, in the current example, n=1, the best method is selected based on d′(M, n) such that if d′ (Method 1, n)<d′ (Method 2, n), Method 1 generates forecasts closer to the actual performance than Method 2, and Method 1 is selected for the given forecasting horizon n. Using the selected best method and the given forecasting horizon, the value d′ is obtained.

Benchmark analysis program 132 issues a benchmark forecast at the determined forecasting horizon (step 210). Using the latest data and the same length of data as used above in the training set, for example, 18 months of historical data, at forecasting horizon n and using the best method selected above, the forecast for an industry benchmark value is calculated. For example, using the rolling window schema described above, with 18 months of historical data and the length of the data in the training set, or the rolling window, is 12, and a forecasting horizon n=1, the latest 12 months of data is used, month 7 to month 18, to generate a forecast for month 19, the future month.

Benchmark analysis program 132 sets a performance target (step 212). Benchmark analysis program 132, after selecting an appropriate method for forecasting horizon n, sets the performance target to be equal to or greater than a threshold value, which is equal to [forecast+d′]. In [forecast+d′], forecast is the forecast benchmark value issued from step 210, and d′ is obtained using the selected best method, M, such that d′(M, n) is set equal to the inverse of function f( ). In various embodiments of the present invention, the determination whether to set the performance target equal to, or greater than, [forecast+d′] is made by a user operating user computing device 120 based on a number of considerations, including whether the performance target is set for an entire organization, or for departments or individuals within the organization.

Referring to FIG. 3A, an exemplary user interface displays a plot of forecast benchmarks compared to actual benchmark performance, from operation of benchmark analysis program 132, in accordance with an embodiment of the present invention.

Plot 300, which can be displayed on a UI, such as UI 122 on user computing device 120, depicts actual benchmark performance values from historical data for each time period (“BENCHMARK” on plot 300), compared with forecast benchmark values for each time period (“FORECAST” on plot 300). The difference between the actual value and the forecast value gives the forecast error, which benchmark analysis program 132 uses to determine the probability, or percentage, of the actual benchmark value meeting or exceeding a [forecast+d] value.

Referring to FIG. 3B, an exemplary user interface displays a plot of a step function determined by benchmark analysis program 132, and a corresponding smooth line representing function f( ), in accordance with an embodiment of the present invention.

Plot 320, which can be displayed on a UI, such as UI 122 on user computing device 120, depicts varying values of d on the x-axis and corresponding calculated probability values on the y-axis. The step function depicted represents a probability of the actual benchmark meeting or exceeding a [forecast+d] value. As the value of d increases, indicating a higher [forecast+d], or performance target, the probability that the actual industry benchmark will meet or exceed the performance target decreases. A smoothing technique is applied to the step function to provide a smooth line representing function f( ). The inverse of function f( ) provides a d′ value, used to set the performance target equal to [forecast+d′]. Plot 320 is an example of a function f( ) given method M and forecasting horizon n, and therefore, function f( ) may also be used to determine method M.

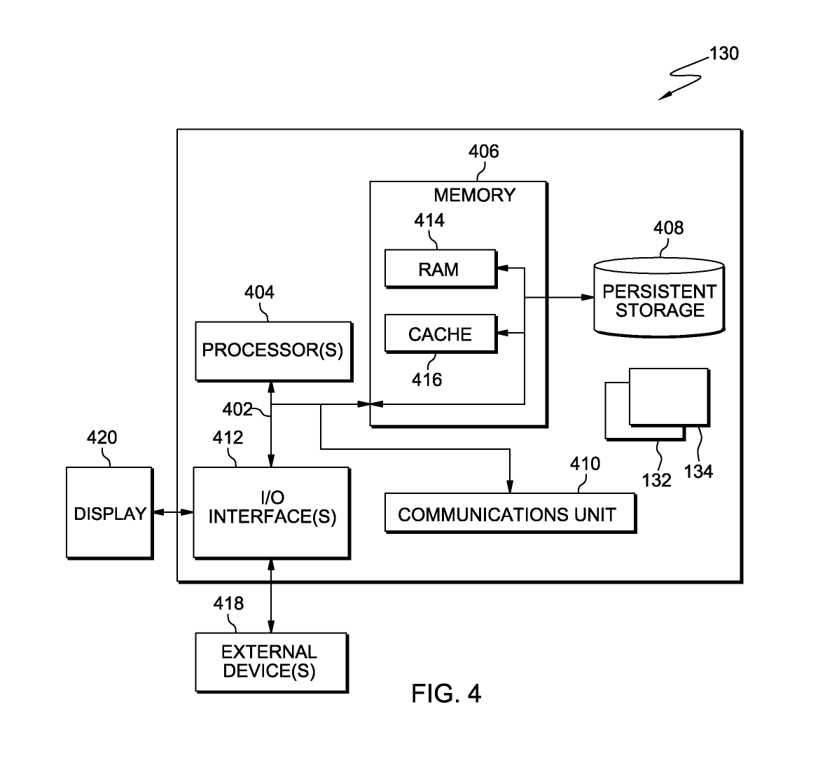

Referring to FIG. 4, components of server computing device 130, in accordance with an illustrative embodiment of the present invention, are shown. It should be appreciated that FIG. 4 provides only an illustration of one implementation and does not imply any limitations with regard to the environments in which different embodiments may be implemented. Many modifications to the depicted environment may be made.

Server computing device 130 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Benchmark analysis program 132 and database 134 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including user computing device 120. In these examples, communications unit 410 includes one or more network interface cards. Communications unit 410 may provide communications through the use of either or both physical and wireless communication links. Benchmark analysis program 132 and database 134 may be downloaded to persistent storage 408 through communications unit 410.

I/O interface(s) 412 allows for input and output of data with other devices that may be connected to server computing device 130. For example, I/O interface 412 may provide a connection to external device(s) 418 such as a keyboard, keypad, a touch screen, and/or some other suitable input device. External device(s) 418 can also include portable computer-readable storage media such as, for example, thumb drives, portable optical or magnetic disks, and memory cards. Software and data used to practice embodiments of the present invention, e.g., benchmark analysis program 132 and database 134, can be stored on such portable computer-readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for setting a performance target in an outcome driven business model, the method comprising:
receiving, by one or more computer processors, historical data comprising industry performance data for an outcome driven business model;
receiving, by the one or more computer processors, performance target setting parameters, the performance target setting parameters including at least a forecasting horizon and a confidence level;
calculating, by the one or more computer processors, for a plurality of forecasting methods and the forecasting horizon, a function associated with a probability of an industry benchmark performance meeting a threshold value;
determining, by the one or more computer processors, based, at least in part, on the function for each of the plurality of forecasting methods, a best forecasting method of the plurality of forecasting methods at the forecasting horizon and the confidence level;
calculating, by the one or more computer processors, based, at least in part, on the historical data and the forecasting horizon, using the determined best forecasting method, a forecast benchmark value; and
setting, by the one or more computer processors, a performance target based on the forecast benchmark value, the confidence level, and the calculated function for the determined best forecasting method.

2. The method of claim 1, wherein calculating, by the one or more computer processors, for a plurality of forecasting methods and the forecasting horizon, the function associated with a probability of an industry benchmark performance meeting a threshold value further comprises:
generating, by the one or more computer processors, using each of the plurality of forecasting methods and the forecasting horizon, a series of forecast values at a corresponding series of historical time points;
determining, by the one or more computer processors, a difference between each of the series of forecast values and the historical data at the corresponding series of historical time points; and
generating, by the one or more computer processors, for each of the plurality of forecasting methods, based, at least in part, on the determined difference and the forecasting horizon, a decreasing function.

3. The method of claim 2, further comprising, wherein the decreasing function is a step function plot, applying, by the one or more computer processors, a smoothing technique to the step function plot.

4. The method of claim 1, wherein determining, by the one or more computer processors, a best forecasting method of the plurality of forecasting methods at the forecasting horizon and the confidence level further comprises:
determining, by the one or more computer processors, results using the calculated function of each of the plurality of forecasting methods, the forecasting horizon and the confidence level;
comparing, by the one or more computer processors, the results using a first forecasting method and the results using a second forecasting method with the historical data;
determining, by the one or more computer processors, the results using the first forecasting method are closer to the historical data than the results using the second forecasting method; and
in response, determining, by the one or more computer processors, the first forecasting method is the best forecasting method.

5. The method of claim 1, wherein setting the performance target further comprises:
determining, by the one or more computer processors, an inverse of the function, based, at least in part, on the confidence level;
calculating, by the one or more computer processors, the threshold value, wherein the threshold value is equal to the inverse of the function added to the forecast benchmark value; and
setting, by the one or more computer processors, the performance target at the threshold value.

6. The method of claim 5, wherein setting the performance target includes setting the performance target above the threshold value.

7. The method of claim 1, wherein the historical data includes trends, seasonal changes, and yearly effects on the industry performance data.

8. A computer system for setting a performance target in an outcome driven business model, the computer system comprising:
one or more computer processors;
one or more computer-readable tangible storage media;
program instructions stored on the one or more computer-readable tangible storage media for execution by at least one of the one or more computer processors, the program instructions comprising:
program instructions to receive historical data comprising industry performance data for an outcome driven business model;
program instructions to receive performance target setting parameters, the performance target setting parameters including at least a forecasting horizon and a confidence level;
program instructions to calculate for a plurality of forecasting methods and the forecasting horizon, a function associated with a probability of an industry benchmark performance meeting a threshold value;
program instructions to determine, based, at least in part, on the function for each of the plurality of forecasting methods, a best forecasting method of the plurality of forecasting methods at the forecasting horizon and the confidence level;
program instructions to calculate, based, at least in part, on the historical data and the forecasting horizon, using the determined best forecasting method, a forecast benchmark value; and
program instructions to set a performance target based on the forecast benchmark value, the confidence level, and the calculated function for the determined best forecasting method.

9. The computer system of claim 8, wherein the program instructions to calculate, for a plurality of forecasting methods and the forecasting horizon, the function associated with a probability of an industry benchmark performance meeting a threshold value further comprises:
program instructions to generate using each of the plurality of forecasting methods and the forecasting horizon, a series of forecast values at a corresponding series of historical time points;
program instructions to determine a difference between each of the series of forecast values and the historical data at the corresponding series of historical time points; and
program instructions to generate for each of the plurality of forecasting methods, based, at least in part, on the determined difference and the forecasting horizon, a decreasing function.

10. The computer system of claim 9, further comprising, wherein the decreasing function is a step function plot, program instructions to apply a smoothing technique to the step function plot.

11. The computer system of claim 8, wherein the program instructions to determine a best forecasting method of the plurality of forecasting methods at the forecasting horizon and the confidence level further comprise:
program instructions to determine results using the calculated function of each of the plurality of forecasting methods, the forecasting horizon and the confidence level;
program instructions to compare the results using a first forecasting method and the results using a second forecasting method with the historical data;
program instructions to determine the results using the first forecasting method are closer to the historical data than the results using the second forecasting method; and
in response, program instructions to determine the first forecasting method is the best forecasting method.

12. The computer system of claim 8, wherein the program instructions to set the performance target further comprise:
program instructions to determine an inverse of the function, based, at least in part, on the confidence level;
program instructions to calculate the threshold value, wherein the threshold value is equal to the inverse of the function added to the forecast benchmark value; and
program instructions to set the performance target at the threshold value.

13. The computer system of claim 12, wherein the program instructions to set the performance target include program instructions to set the performance target above the threshold value.

14. A computer program product for setting a performance target in an outcome driven business model, the computer program product comprising:
a computer-readable tangible storage media having, stored thereon:
program instructions to receive historical data comprising industry performance data for an outcome driven business model;
program instructions to receive performance target setting parameters, the performance target setting parameters including at least a forecasting horizon and a confidence level;
program instructions to calculate for a plurality of forecasting methods and the forecasting horizon, a function associated with a probability of an industry benchmark performance meeting a threshold value;
program instructions to determine, based, at least in part, on the function for each of the plurality of forecasting methods, a best forecasting method of the plurality of forecasting methods at the forecasting horizon and the confidence level;
program instructions to calculate, based, at least in part, on the historical data and the forecasting horizon, using the determined best forecasting method, a forecast benchmark value; and
program instructions to set a performance target based on the forecast benchmark value, the confidence level, and the calculated function for the determined best forecasting method.

15. The computer program product of claim 14, wherein the program instructions to calculate, for a plurality of forecasting methods and the forecasting horizon, the function associated with a probability of an industry benchmark performance meeting a threshold value further comprise:
program instructions to generate, using each of the plurality of forecasting methods and the forecasting horizon, a series of forecast values at a corresponding series of historical time points;
program instructions to determine a difference between each of the series of forecast values and the historical data at the corresponding series of historical time points; and
program instructions to generate for each of the plurality of forecasting methods, based, at least in part, on the determined difference and the forecasting horizon, a decreasing function.

16. The computer program product of claim 15, further comprising, wherein the decreasing function is a step function plot, program instructions to apply a smoothing technique to the step function plot.

17. The computer program product of claim 14, wherein the program instructions to determine a best forecasting method of the plurality of forecasting methods at the forecasting horizon and the confidence level further comprise:
program instructions to determine results using the calculated function of each of the plurality of forecasting methods, the forecasting horizon and the confidence level;
program instructions to compare the results using a first forecasting method and the results using a second forecasting method with the historical data;
program instructions to determine the results using the first forecasting method are closer to the historical data than the results using the second forecasting method; and
in response, program instructions to determine the first forecasting method is the best forecasting method.

18. The computer program product of claim 14, wherein the program instructions to set the performance target further comprise:
program instructions to determine an inverse of the function, based, at least in part, on the confidence level;
program instructions to calculate the threshold value, wherein the threshold value is equal to the inverse of the function added to the forecast benchmark value; and
program instructions to set the performance target at the threshold value.

19. The computer program product of claim 18, wherein the program instructions to set the performance target include program instructions to set the performance target above the threshold value.

20. The computer program product of claim 14, wherein the historical data includes trends, seasonal changes, and yearly effects on the industry performance data.
